(19) United States
(12) Patent Application Publication
(10) Pub. No.: US 2012/0325916 A1
(43) Pub. Date: Dec. 27, 2012

(54) RFID MODULE AND RFID DEVICE

(75) Inventors: Nobuhito TSUBAKI, Nagaokakyo-shi (JP); Katsumi TANIGUCHI, Nagaokakyo-shi (JP); Noboru KATO, Nagaokakyo-shi (JP)

(73) Assignee: MURATA MANUFACTURING CO., LTD., Nagaokakyo-shi (JP)

(21) Appl. No.: 13/603,627

(22) Filed: Sep. 5, 2012

Related U.S. Application Data
(63) Continuation of application No. PCT/JP2011/069689, filed on Aug. 31, 2011.

(30) Foreign Application Priority Data
Sep. 6, 2010 (JP) 2010-199286
Sep. 6, 2010 (JP) 2010-199287

(51) Int. Cl. G06K 19/073

(52) U.S. Cl. 235/492

(57) ABSTRACT

An RFID module includes an RFIC element, a filter circuit, a matching circuit, and a radiating element. The filter circuit and the matching circuit define an RFID device. The filter circuit includes a first inductance element, a second inductance element, and a capacitor. The first inductance element and the second inductance element are of equal inductance, and are strongly magnetically coupled to each other so as to strengthen magnetic fluxes to each other. With this configuration, an RFID module and an RFID device that include a filter circuit to remove harmonic components of the RFIC element but are not large as a whole are constructed.

### BACKGROUND OF THE INVENTION

1. Field of the Invention

The present invention relates to an RFID (Radio Frequency Identification) module preferably for use in, for example, an RFID system, and an RFID device included in an RFID module.

2. Description of the Related Art

As a product management system, an RFID system is known in which an RFID tag and a reader/writer contactlessly communicate with each other so that information is transmitted between the RFID tag and the reader/writer. The RFID tag includes an RFIC element having ID information written therein and an antenna for transmitting and receiving an RF signal.

In such an RFID tag, as disclosed in, for example, Japanese Unexamined Patent Application Publication No. 2004-145449, a filter may be provided between the RFIC element and the antenna to remove harmonic components generated by the RFIC element. Further, as disclosed in, for example, Japanese Unexamined Patent Application Publication No. 2001-188890 and Japanese Unexamined Patent Application Publication No. 2009-027291, a matching circuit including a capacitor and a coil is disposed between the RFIC element and the antenna to achieve impedance matching between the RFIC element and the antenna.

Here, the configuration of an IC module disclosed in Japanese Unexamined Patent Application Publication No. 2004-145449 is illustrated in FIG. 1. The IC module includes a reader/writer transmitting circuit, a reader/writer receiving circuit, and a card IC circuit. Antennas are connected to input and output terminals of the circuit modules so that a reader/writer performs contactless communication with an external card IC. Filters are disposed between the reader/writer transmitting circuit and the reader/writer transmitting and receiving antenna.

The filter, described above, for removing harmonic components generated by the RFIC element is formed of a low-pass filter including a capacitor and an inductor. Since the filter requires an inductor having a relatively large inductance value, the inductor element is large, leading to an increased size of the RFID tag.

### SUMMARY OF THE INVENTION

Accordingly, preferred embodiments of the present invention provide an RFID module and an RFID device that include a filter circuit that removes harmonic components of an RFIC element but are not large as a whole.

An RFID module according to a preferred embodiment of the present invention includes an RFIC element including a first input/output terminal and a second input/output terminal, a filter circuit that removes harmonic components of the RFIC element, the filter circuit including a first inductance element connected to the first input/output terminal, and a second inductance element connected to the second input/output terminal, and a radiating element connected to the filter circuit, wherein the first inductance element and the second inductance element are magnetically coupled to each other.

For compactness, preferably, a coupling coefficient between the first inductance element and the second inductance element is greater than or equal to about 0.7, for example.

A matching circuit including an inductance element and a capacitance element or including an inductance element or a capacitance element may preferably be provided between the filter circuit and the radiating element.

Preferably, the first inductance element includes a first laminated coil element in which a plurality of loop-shaped conductors are laminated, the second inductance element includes a second laminated coil element in which a plurality of loop-shaped conductors are laminated, and a winding axis of the loop-shaped conductors of the first laminated coil element is substantially aligned with a winding axis of the loop-shaped conductors of the second laminated coil element. With this structure, the amount of magnetic flux passing within each loop-shaped conductor is greatly increased and reaches a maximum. Thus, the coupling coefficient is significantly increased, and the size of an inductor in a filter is significantly reduced.

The loop-shaped conductors of the first laminated coil element and the loop-shaped conductors of the second laminated coil element preferably may be alternately laminated. With this structure, the coupling coefficient is significantly increased, and the size of an inductor in a filter is significantly reduced.

Preferably, the first inductance element and the second inductance element are included in a multi-layer substrate including a plurality of magnetic layers laminated on each other. With this structure, the coupling coefficient can be increased, and the size of an inductor in a filter can be reduced.

The inductance element or the capacitance element of the matching circuit is mounted on, for example, a surface of the multi-layer substrate. With this structure, a matching circuit is provided substantially without increasing the overall size.

Preferably, the RFID module further includes, if necessary, a booster element that is coupled to the radiating element through an electromagnetic field and that receives or transmits a radio signal.

Preferably, the radiating element includes a coil-shaped conductor, and the coil-shaped conductor and the booster element are electromagnetically coupled to each other.

Preferably, the radiating element is included in the multi-layer substrate. With this structure, a radiating element is provided substantially without increasing the overall size.

An RFID device according to another preferred embodiment of the present invention is provided between an RFIC element and a radiating element, the RFIC element including a first input/output terminal and a second input/output terminal, and a filter portion has a configuration as described above.

Preferably, the RFID device further includes a matching circuit connected on a side of the filter circuit which is near the radiating element, the matching circuit including an inductance element and a capacitance element or including an inductance element or a capacitance element.

According to various preferred embodiments of the present invention, an inductor in a filter circuit that removes harmonic components of an RFIC element is significantly reduced in size, and a small RFID module and RFID device is constructed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating the configuration of an IC module disclosed in Japanese Unexamined Patent Application Publication No. 2004-145449.

FIG. 2 is a circuit diagram of an RFID module 101 according to a first preferred embodiment of the present invention.

FIGS. 3A and 3B include diagrams illustrating that a filter circuit 20 illustrated in FIG. 2 is included in a multi-layer substrate including a plurality of magnetic layers laminated on each other, in which FIG. 3A is a see-through perspective view of inner conductor layers and FIG. 3B is a perspective view depicting the inner conductor layers which are enlarged in the thickness direction.

FIG. 4 includes plan views of the respective conductor layers of the multi-layer substrate.

FIG. 5 includes diagrams illustrating the connection relationship of via conductors connecting the respective conductor layers of the multi-layer substrate.

FIG. 6A is a perspective view of a simplified representation of the arrangement relationship between a first inductance element L1 and a second inductance element L2 illustrated in FIG. 3, and FIG. 6B is a diagram of a comparative example thereof.

FIG. 7A is a plan view of an RFID device 50 illustrated in FIG. 2, and FIG. 7B is a bottom view thereof.

FIG. 8 is a configuration diagram of an RFID module 101 including the RFID device 50.

FIG. 9 is a diagram illustrating the relationship between the resonant frequency of an RFID tag and the communication distance limit.

FIGS. 10A and 10B include diagrams illustrating the configuration of a filter circuit unit of an RFID device according to a second preferred embodiment of the present invention, in which FIG. 10A is a see-through perspective view of inner conductor layers and FIG. 10B is a perspective view depicting the inner conductor layers which are enlarged in the thickness direction.

FIG. 11 is a perspective view of a simplified representation of the arrangement relationship between a first inductance element L1 and a second inductance element L2 illustrated in FIG. 10.

FIG. 12 is a circuit diagram of an RFID module 103 according to a third preferred embodiment of the present invention.

FIG. 13A is a plan view of an RFID device 50 illustrated in FIG. 12, and FIG. 13B is a cross-sectional view thereof.

FIG. 14 is a configuration diagram of an RFID module 103 including the RFID device 50.

FIG. 15 is a diagram illustrating a current flowing in coil conductors of a coupling radiating element 40C and a current flowing in a booster electrode 62 of a booster element 60.

FIG. 16 is a diagram illustrating the relationship between the resonant frequency of an RFID tag and the communication distance limit.

FIG. 17 is an exploded perspective view of an RFID module 104 according to a fourth preferred embodiment of the present invention.

FIG. 18A and FIG. 18B are diagrams illustrating two configurations of an RFID device according to a fifth preferred embodiment of the present invention.

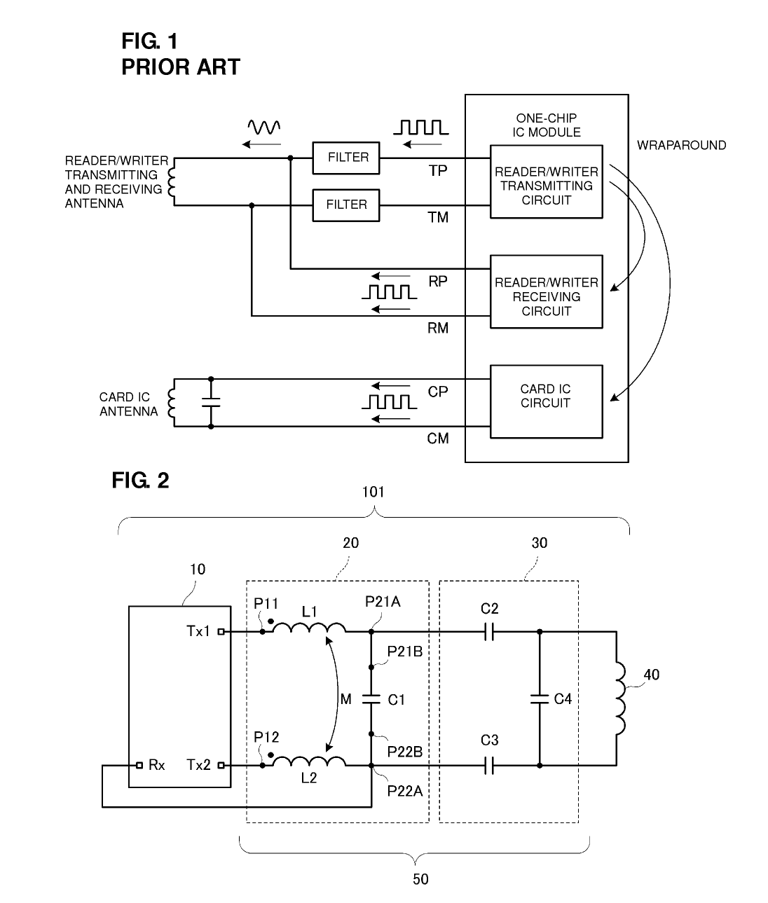

### DETAILED DESCRIPTION OF THE PREFERRED EMBODIMENTS

### First Preferred Embodiment

FIG. 2 is a circuit diagram of an RFID module 101 according to a first preferred embodiment of the present invention. The RFID module 101 preferably includes an RFIC element 10, a filter circuit 20, a matching circuit 30, and a radiating element 40. The filter circuit 20 and the matching circuit 30 define an RFID device 50.

In the first preferred embodiment, the RFID device 50 preferably includes the filter circuit 20 and the matching circuit 30; however, the RFID device 50 include only the filter circuit 20.

The RFIC element 10 includes a semiconductor integrated circuit, a first transmitting terminal Tx1, a second transmitting terminal Tx2, and a receiving terminal Rx. The first transmitting terminal Tx1 and the second transmitting terminal Tx2 provide a balanced output of transmission signals. The receiving terminal Rx provides an unbalanced input of a received signal. The first transmitting terminal Tx1 and the second transmitting terminal Tx2 correspond to a “first input/output terminal” and a “second input/output terminal” according to a preferred embodiment of the present invention, respectively.

The filter circuit 20 includes a first inductance element L1, a second inductance element L2, and a capacitor C1. A first end of the first inductance element L1 is connected to the first transmitting terminal Tx1 of the RFIC element 10, and a first end of the second inductance element L2 is connected to the second transmitting terminal Tx2 of the RFIC element 10. Second ends of the first inductance element L1 and the second inductance element L2 are connected to both ends of the capacitor C1. The filter circuit 20 removes harmonic components included in the transmission signals of the RFIC element 10.

The matching circuit 30 includes capacitors C2, C3, and C4. A first end of the capacitor C2 is connected to a first output end of the filter circuit 20, and a first end of the capacitor C3 is connected to a second output end of the filter circuit 20. Second ends of the capacitors C2 and C3 are connected to both ends of the capacitor C4.

The radiating element 40 is, for example, a loop-shaped coil antenna.

The first inductance element L1 and the second inductance element L2 are of equal inductance or substantially equal inductance. Further, the first inductance element L1 and the second inductance element L2 are magnetically coupled to each other so as to strengthen magnetic fluxes relative to each other. In one example, if the inductance of the first inductance element L1, which is in an uncoupled state, is represented by L10, the inductance of the second inductance element L2, which is in an uncoupled state, is represented by L20, the mutual inductance of both inductance elements is represented by M, the coupling coefficient is represented by k, the inductance of the first inductance element L1, which is in a coupled state, is represented by L1, and the inductance of the second inductance element L2, which is in a coupled state, is represented by L2, then, the effective inductance L of the inductors connected between Tx1 and the capacitor C1 and between Tx2 and the capacitor C1 is represented by

L=L10+L20+2M

=L10+L20+2k×√(L10*L20)

L1=L2=L/2.

For example, if the required inductances L10 and L20 of L1 and L2 are 800 nH (L1=L2=L10=L20=800 nH) when the coupling coefficient k=0, the inductances L10 and L20 required for L1 and L2 to be 800 nH when the coupling coefficient k=0.85 are 432 nH, for example. That is, a reduction of about 0.54 times, for example, can be provided. In addition, the length of a loop-shaped conductor required to obtain the required inductances is significantly reduced, and the direct-current resistance is significantly reduced accordingly.

The matching circuit 30 provides impedance matching between the filter circuit 20 and the radiating element 40 preferably by including the three capacitors C2, C3, and C4, for example.

The receiving terminal Rx of the RFIC element 10 is connected to one end of the capacitor C1, and a received signal is input to the receiving terminal Rx.

The RFIC element 10 provides a balanced output of about 13.56 MHz square wave signals from the transmitting terminals Tx1 and Tx2, for example. Therefore, the radiating element 40 is driven through the filter circuit 20 and the matching circuit 30, and an approximately 13.56 MHz magnetic field is radiated from the radiating element 40. If an RFID tag is located near the radiating element 40, the RFID tag receives the magnetic field signal to receive electric power, and changes the impedance of a wireless IC in the RFID tag on the basis of the ID of the RFID tag to change the impedance of an antenna resonance circuit on the RFID tag side (i.e., perform ASK modulation). Thus, the RFID tag returns the ID by reflection of energy.

The RFIC element 10 decodes the ID in response to the ASK-modulated response signal. When transmitting data or a command, the RFIC element 10 ASK-modulates the 13.56 MHz driving voltage (current) described above. The RFID tag decodes changes in the intensity of a received carrier so as to receive the data or command from the RFIC element 10.

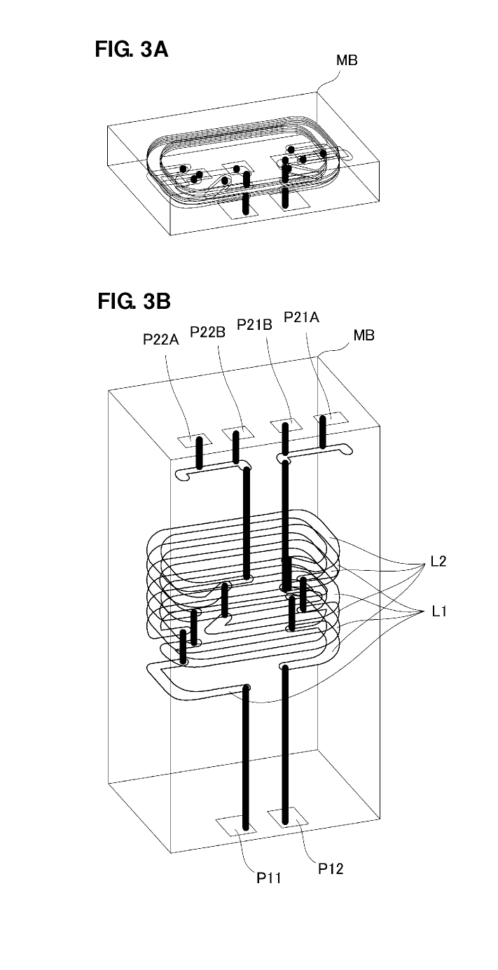

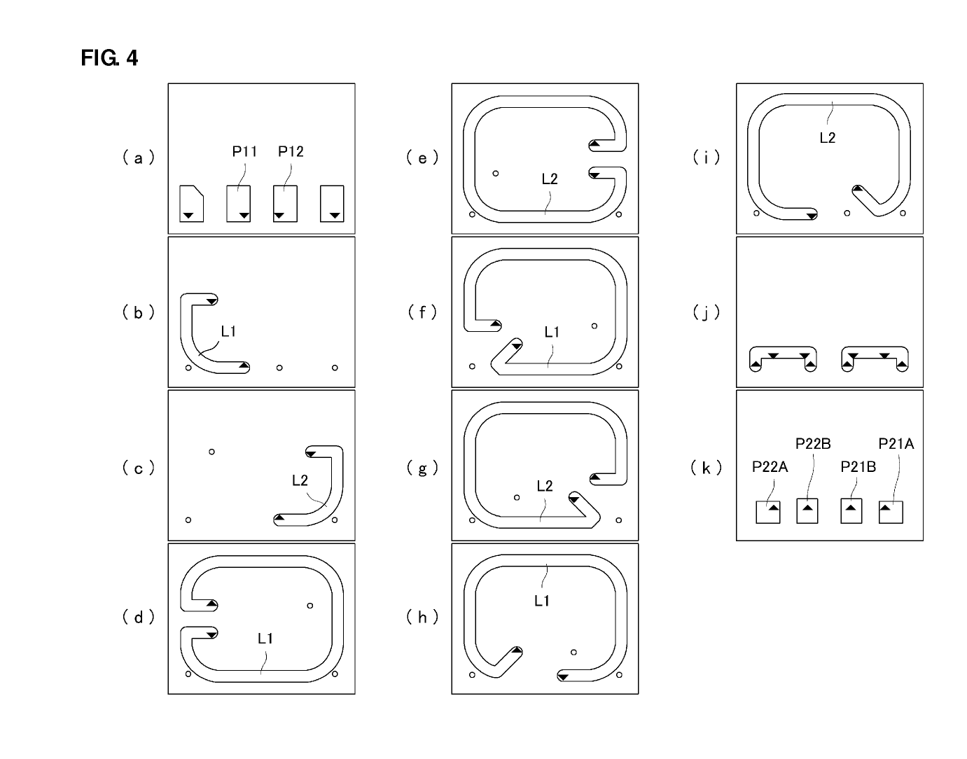

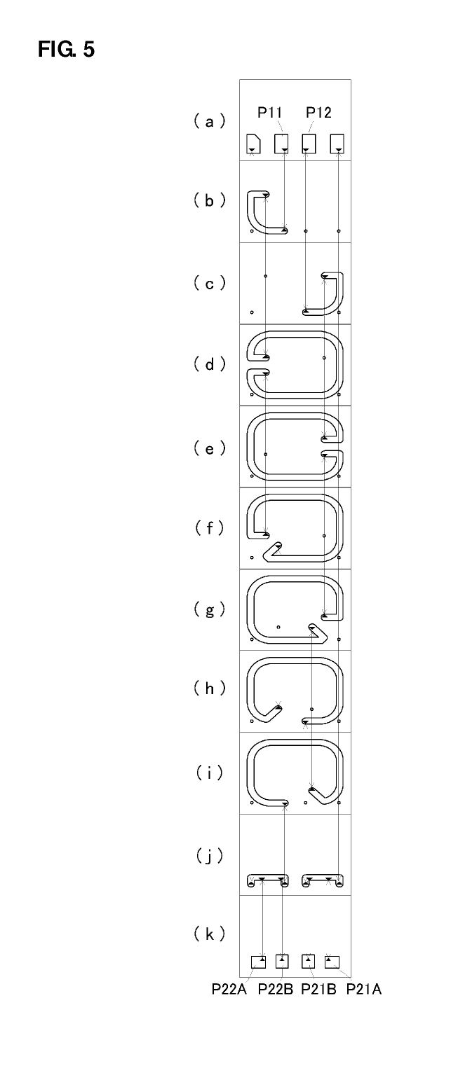

FIGS. 3A and 3B include diagrams illustrating that the filter circuit 20 illustrated in FIG. 2 is included in a multi-layer substrate including a plurality of magnetic layers laminated on each other. FIG. 3A is a see-through perspective view of inner conductor layers, and FIG. 3B is a perspective view depicting the inner conductor layers which are enlarged in the thickness direction. FIG. 4 includes plan views of the respective conductor layers of the multi-layer substrate, and FIG. 5 includes diagrams illustrating the connection relationship of via conductors connecting the respective conductor layers.

In FIG. 4 and FIG. 5, layer (a) is a bottom layer and layer (k) is a top layer. In FIG. 5, a via conductor is represented by a thin straight line.

As depicted in FIG. 3B and the like, in a multi-layer substrate MB, the first inductance element L1 includes a helically wound first laminated coil element in which a plurality of loop-shaped conductors are laminated, and the second inductance element L2 includes a helically wound second laminated coil element in which a plurality of loop-shaped conductors are laminated.

Terminal electrodes P21A, P21B, P22A, and P22B are provided on an upper surface of the multi-layer substrate MB. Terminal electrodes P11 and P12 are provided on a lower surface of the multi-layer substrate MB. These terminal electrodes represent the elements denoted by the corresponding numerals in the circuit illustrated in FIG. 2. As described below, a chip capacitor corresponding to the capacitor C1 is provided on the terminal electrodes P21B and P22B. Further, chip capacitors corresponding to the capacitors C2 and C3 are arranged so that one end of the chip capacitor corresponding to the capacitor C2 is connected to the terminal electrode P21A and one end of the chip capacitor corresponding to the capacitor C3 is connected to the terminal electrode P22A. The RFIC element 10 is connected to the terminal electrodes P11 and P12.

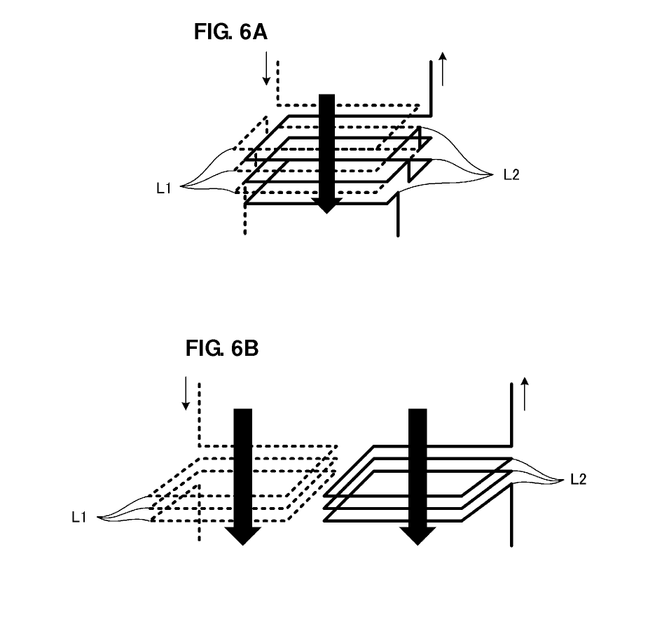

FIG. 6A is a perspective view of a simplified representation of the arrangement relationship between the first inductance element L1 and the second inductance element L2 illustrated in FIG. 3. FIG. 6B is a diagram of a comparative example thereof. In a preferred embodiment of the present invention, the first inductance element L1 includes the first laminated coil element in which a plurality of loop-shaped conductors are laminated, and the second inductance element L2 includes the second laminated coil element in which a plurality of loop-shaped conductors are laminated. The winding axis of the loop-shaped conductors of the first laminated coil element is substantially aligned with, or coaxial with, the winding axis of the loop-shaped conductors of the second laminated coil element. Thus, the aperture of the first laminated coil element and the aperture of the second laminated coil element overlap when viewed in plan. In the example illustrated in FIG. 3B and FIG. 6A, furthermore, the loop-shaped conductors of the first laminated coil element and the loop-shaped conductors of the second laminated coil element are alternately laminated. With the above arrangement of the loop-shaped conductors, the coupling coefficient k of the first inductance element L1 and the second inductance element L2 is about 0.85, for example.

As in the comparative example in FIG. 6B, when the first laminated coil element of the first inductance element L1 and the second laminated coil element of the second inductance element L2 are located side-by-side, the coupling coefficient k of the first inductance element L1 and the second inductance element L2 is substantially 0.

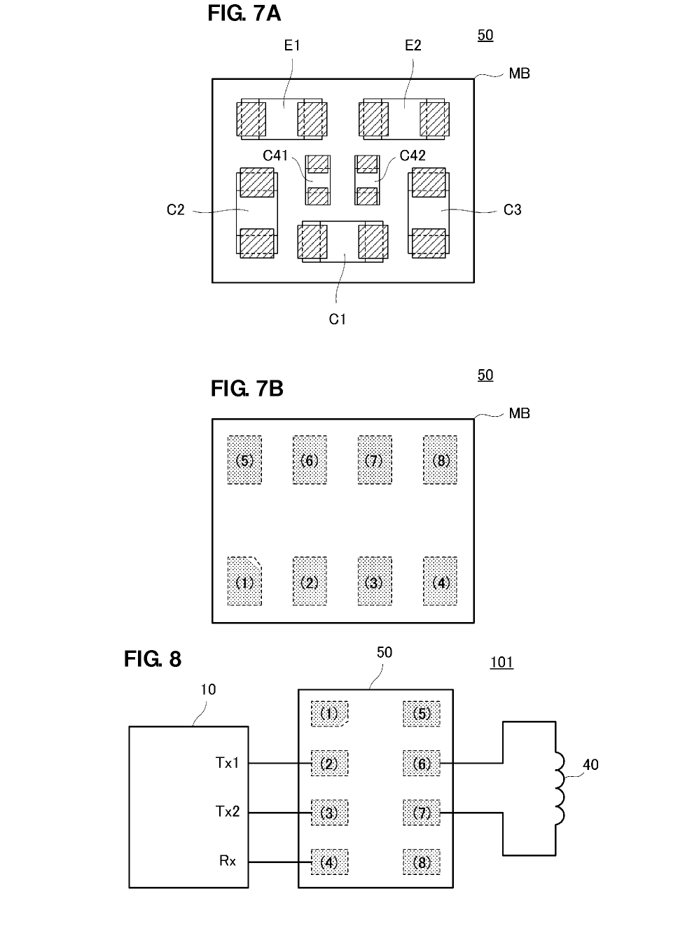

FIG. 7A is a plan view of the RFID device 50 illustrated in FIG. 2, and FIG. 7B is a bottom view thereof. As depicted in FIG. 7A, chip capacitors C1, C2, C3, C41, and C42 and ESD protection elements E1 and E2 are mounted on the upper surface of the multi-layer substrate MB. Here, the capacitors C1, C2, and C3 represent the elements denoted by the corresponding numerals illustrated in FIG. 2. The capacitors C41 and C42 are connected in parallel to each other, and correspond to the capacitor C4 in FIG. 2. The ESD protection elements E1 and E2 are disposed between the radiating element 40 illustrated in FIG. 2 and a ground.

As depicted in FIG. 7B, connection terminals (2) and (3) of the transmitting terminals Tx1 and Tx2, a connection terminal (4) of the receiving terminal Rx, connection terminals (6) and (7) of the radiating element 40, ground terminals (5) and (8), and an NC terminal (1) are provided on the lower surface of the multi-layer substrate MB.

The coupling coefficient k of the first inductance element L1 and the second inductance element L2 illustrated in FIG. 3 preferably is about 0.85, for example, and the first inductance element L1 and the second inductance element L2 are strongly coupled, thus reducing the size required to obtain the required inductances. The size of the multi-layer substrate MB is significantly reduced, and the size of the RFID device 50 is significantly reduced. When the first inductance element L1 and the second inductance element L2 are defined by chip inductors, a size of approximately 15 mm×6 mm=90 mm² is required. In contrast, according to the first preferred embodiment, the first and second inductance elements are strongly coupled to reduce size. In addition, the first and second inductance elements are included in the multi-layer substrate so that their winding axes are substantially aligned with each other to allow the first and second inductance elements to be strongly coupled to reduce size. Moreover, elements such as chip capacitors are mounted on the multi-layer substrate, thus achieving a size of about 3.2 mm×2.5 mm=8 mm², for example. Therefore, the area ratio becomes about 1/10 or less, for example.

FIG. 8 is a configuration diagram of the RFID module 101 including the RFID device 50. Since the size of the RFID device 50 is reduced, the RFID device 50 can be located near the RFIC element 10, and the size of the RFID module 101 can be reduced.

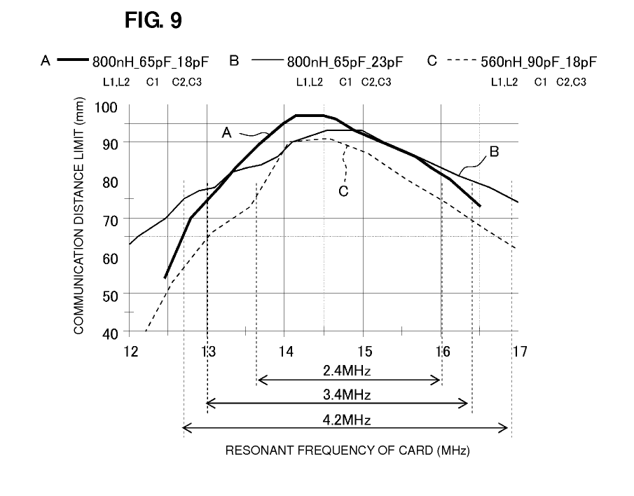

FIG. 9 is a diagram illustrating the relationship between the resonant frequency of an RFID tag and the communication distance limit. The correspondence relationships between characteristic curves A, B, and C and the value of each element of the filter circuit 20 and the matching circuit 30 preferably are as follows:

### Characteristic Curve [A]

L1, L2: 800 nH
C1: 65 pF
C2, C3: 18 pF

### Characteristic Curve [B]

L1, L2: 800 nH
C1: 65 pF
C2, C3: 23 pF

### Characteristic Curve [C]

L1, L2: 560 nH
C1: 90 pF
C2, C3: 18 pF

In a condition where communication is performed in a communication distance within about 75 mm, for example, an RFID device having the characteristic curve A can perform communication within a range of frequency bands from about 13 MHz to about 16.4 MHz (a frequency bandwidth of about 3.4 MHz), for example. An RFID device having the characteristic curve B can perform communication within a range of frequency bands from about 12.7 MHz to about 16.9 MHz (a frequency bandwidth of about 4.2 MHz), for example. An RFID device having the characteristic curve C, which is a comparative example, can perform communication within a range of frequency bands from about 13.6 MHz to about 16 MHz (a frequency bandwidth of about 2.4 MHz), for example.

Therefore, since the RFID device having the characteristic curve A has a relatively narrow bandwidth but has a large communication distance limit, this RFID device can be used as a communication-distance-priority RFID device. Since the RFID device having the characteristic curve B has a relatively short communication distance limit but has a wide bandwidth, this RFID device can be used as a bandwidth-priority RFID device. It was discovered both the communication distance and the bandwidth can be significantly increased, as compared to the RFID device having the characteristic curve C, which is a comparative example. In particular, the bandwidth-priority RFID device can provide a bandwidth as large as about 4.2 MHz/2.4 MHz=1.75 times that of the comparative example, for example.

### Second Preferred Embodiment

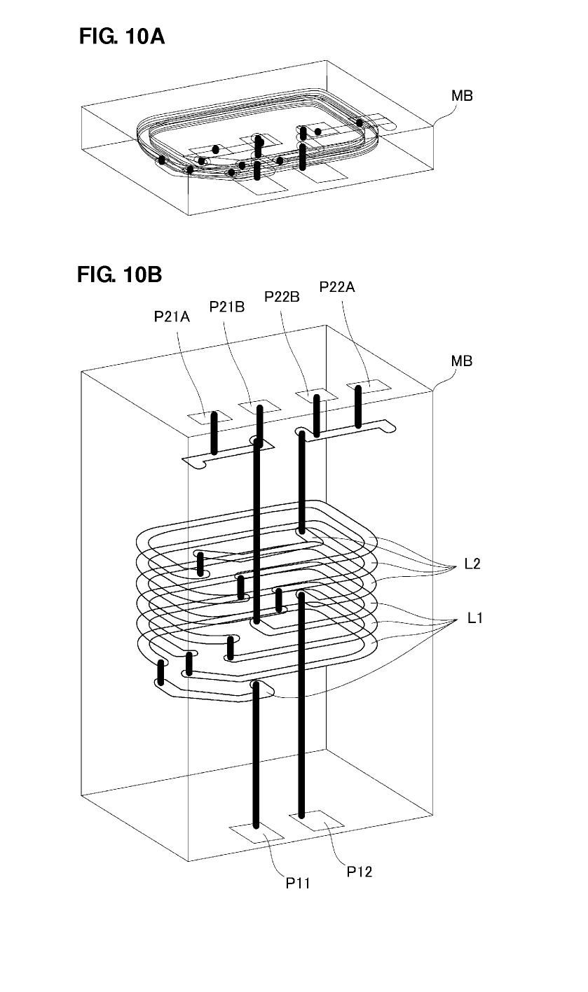

FIGS. 10A and 10B include diagrams illustrating the configuration of a filter circuit unit of an RFID device according to a second preferred embodiment of the present invention. FIG. 10A is a see-through perspective view of inner conductor layers, and FIG. 10B is a perspective view depicting the inner conductor layers which are enlarged in the thickness direction. As depicted in FIG. 10B, in a multi-layer substrate MB, the first inductance element L1 includes a helically wound first laminated coil element in which a plurality of loop-shaped conductors are laminated, and the second inductance element L2 includes a helically wound second laminated coil element in which a plurality of loop-shaped conductors are laminated.

Terminal electrodes P21A, P21B, P22A, and P22B are provided on an upper surface of the multi-layer substrate MB. Terminal electrodes P11 and P12 are provided on a lower surface of the multi-layer substrate MB. These terminal electrodes represent the elements denoted by the corresponding numerals in the circuit illustrated in FIG. 2.

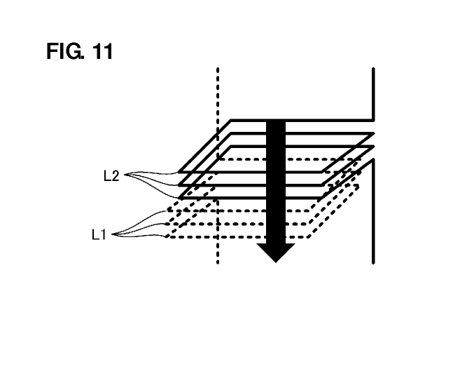

FIG. 11 is a perspective view of a simplified representation of the arrangement relationship between the first inductance element L1 and the second inductance element L2 illustrated in FIG. 10.

The first inductance element L1 includes the first laminated coil element in which the plurality of loop-shaped conductors are laminated, and the second inductance element L2 includes the second laminated coil element in which the plurality of loop-shaped conductors are laminated. The winding axis of the loop-shaped conductors of the first laminated coil element is substantially aligned with the winding axis of the loop-shaped conductors of the second laminated coil element. However, unlike the example illustrated in FIG. 3, the first laminated coil element and the second laminated coil element are laminated such that the first laminated coil element and the second laminated coil element are individually wound.

In this manner, two laminated coil elements may be laminated so as to be individually wound. With this arrangement of loop-shaped conductors, the coupling coefficient k of the first inductance element L1 and the second inductance element L2 is preferably about 0.7, for example.

The following measures are effective to increase the coupling coefficient between the first and second inductance elements:
Increasing the rate of the area of a portion where the loop surfaces of the loop-shaped conductors of the first laminated coil element face the loop surfaces of the loop-shaped conductors of the second laminated coil element.
Reducing the thickness of the magnetic layers (reducing the distance between adjacent loop-shaped conductors).
Using high-permeability magnetic layers.

### Third Preferred Embodiment

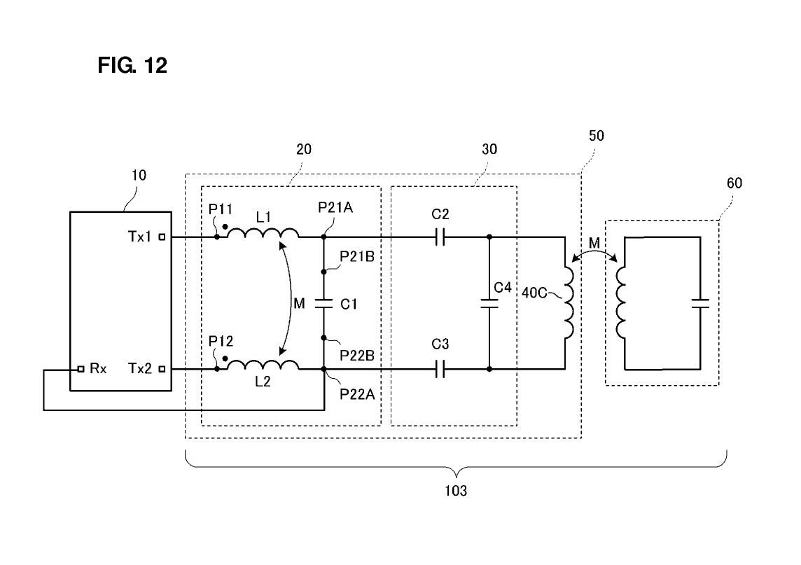

FIG. 12 is a circuit diagram of an RFID module 103 according to a third preferred embodiment of the present invention. The RFID module 103 includes an RFID device 50 and a booster element 60. An RFIC element 10 is connected to the RFID device 50.

The RFID device 50 includes a filter circuit 20, a matching circuit 30, and a coupling radiating element 40C. In the third preferred embodiment, the RFID device 50 includes the filter circuit 20, the matching circuit 30, and the coupling radiating element 40C; however, the RFID device 50 include of the filter circuit 20 and the coupling radiating element 40C.

The RFIC element 10 includes a semiconductor integrated circuit, a first transmitting terminal Tx1, a second transmitting terminal Tx2, and a receiving terminal Rx. The first transmitting terminal Tx1 and the second transmitting terminal Tx2 provide a balanced output of transmission signals. The receiving terminal Rx provides an unbalanced input of a received signal. The first transmitting terminal Tx1 and the second transmitting terminal Tx2 correspond to a “first input/output terminal” and a “second input/output terminal” according to a preferred embodiment of the present invention, respectively.

The filter circuit 20 includes a first inductance element L1, a second inductance element L2, and a capacitor C1. A first end of the first inductance element L1 is connected to the first transmitting terminal Tx1 of the RFIC element 10, and a first end of the second inductance element L2 is connected to the second transmitting terminal Tx2 of the RFIC element 10. Second ends of the first inductance element L1 and the second inductance element L2 are connected to both ends of the capacitor C1. The filter circuit 20 removes harmonic components included in the transmission signals of the RFIC element 10.

The matching circuit 30 includes capacitors C2, C3, and C4. A first end of the capacitor C2 is connected to a first output end of the filter circuit 20, and a first end of the capacitor C3 is connected to a second output end of the filter circuit 20. Second ends of the capacitors C2 and C3 are connected to both ends of the capacitor C4.

The coupling radiating element 40C preferably is, for example, a loop-shaped coil conductor.

The first inductance element L1 and the second inductance element L2 are of equal inductance or substantially equal inductance. Further, the first inductance element L1 and the second inductance element L2 are magnetically coupled to each other so as to strengthen magnetic fluxes to each other.

The coupling radiating element 40C is magnetically coupled to the booster element 60. The booster element 60 is coupled to the coupling radiating element 40C and acts as a radiating element for external radiation.

The third preferred embodiment preferably has the same configuration as that of the RFID module 101 in the first preferred embodiment, except that the coupling radiating element 40C and the booster element 60 are included.

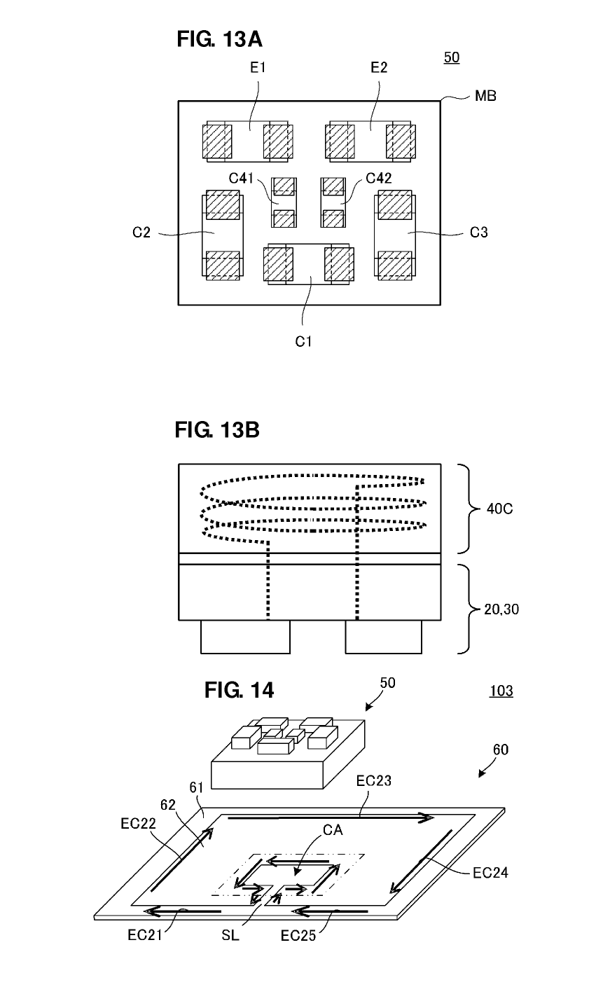

FIG. 13A is a plan view of the RFID device 50 illustrated in FIG. 12, and FIG. 13B is a cross-sectional view thereof. In FIG. 13B, a cross-sectional view enlarged in the thickness direction is depicted. As depicted in FIG. 13A, chip capacitors C1, C2, C3, C41, and C42 and ESD protection elements E1 and E2 are mounted on an upper surface of a multi-layer substrate MB. Here, the capacitors C1, C2, and C3 represent the elements denoted by represented by the corresponding numerals illustrated in FIG. 12. The capacitors C41 and C42 are connected in parallel to each other, and correspond to the capacitor C4 in FIG. 12. The ESD protection elements E1 and E2 are disposed between the coupling radiating element 40C illustrated in FIG. 12 and a ground.

As depicted in FIG. 13B, the coupling radiating element 40C is arranged so as to be laminated with respect to the filter circuit 20 and the matching circuit 30.

FIG. 14 is an exploded perspective view of the RFID module 103 including the RFID device 50. The RFID module 103 is preferably formed by placing the RFID device 50 on the booster element 60. The booster element 60 includes an insulating base and a booster electrode 62 provided on an upper surface of the insulating base 61. The booster electrode 62 preferably is a “C”-shaped conductor film, and is disposed so as to face the coupling radiating element in the RFID device 50. The booster element 60 has a conductor area that overlaps the coupling radiating element when viewed in plan, a conductor aperture (non-conductor area) CA that overlaps the coil aperture of the coupling radiating element when viewed in plan, and a slit portion SL that connects the outer edge of the conductor area and the conductor aperture CA in a continuous fashion. In FIG. 14, a two-dot chain line indicates an area where the RFID device 50 is to be placed.

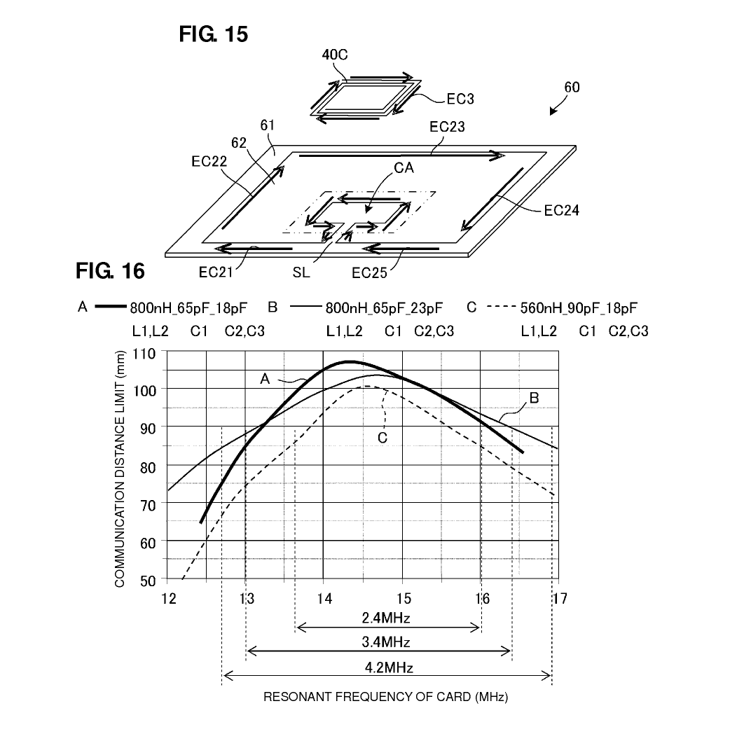

FIG. 15 is a diagram illustrating a current flowing in the coil conductor of the coupling radiating element 40C and a current flowing in the booster electrode 62 of the booster element 60. However, these currents are currents flowing when the coupling radiating element is laminated on the booster element 60.

As illustrated in FIG. 15, when a current EC3 flows in the coil conductor of the coupling radiating element 40C, the magnetic flux generated from the coil conductor is to link with the booster electrode 62. Thus, a current flows in the booster electrode 62 in the direction opposite to the direction of the current flowing in the coil conductor of the coupling radiating element 40C so as to interrupt the magnetic flux. The current flowing around the conductor aperture CA flows along the periphery of the booster electrode 62 through the periphery of the slit portion SL. The flow of current along the periphery of the booster electrode 62 increases the area where a magnetic field is radiated, and the booster electrode 62 serves as a booster that amplifies the magnetic field. Therefore, the coil conductor of the coupling radiating element 40C and the booster electrode 62 are electromagnetically, or more generally, magnetically, coupled to each other.

The current EC3 and currents EC21 to EC25 contribute to radiation. That is, the coupling radiating element 40C and the booster element 60 act as an antenna.

FIG. 16 is a diagram illustrating the relationship between the resonant frequency of an RFID tag and the communication distance limit. The correspondence relationships between characteristic curves A, B, and C and the value of each element of the filter circuit 20 and the matching circuit 30 preferably are as follows:

### Characteristic Curve [A]

L1, L2: 800 nH
C1: 65 pF
C2, C3: 18 pF

### Characteristic Curve [B]

L1, L2: 800 nH
C1: 65 pF
C2, C3: 23 pF

### Characteristic Curve [C]

L1, L2: 560 nH
C1: 90 pF
C2, C3: 18 pF

In a condition where communication is performed in a communication distance within about 85 mm, for example, an RFID device having the characteristic curve A can perform communication within a range of frequency bands from about 13 MHz to about 16.4 MHz (a frequency bandwidth of about 3.4 MHz), for example. An RFID device having the characteristic curve B can perform communication within a range of frequency bands from about 12.7 MHz to about 16.9 MHz (a frequency bandwidth of about 4.2 MHz). An RFID device having the characteristic curve C, which is a comparative example, can perform communication within a range of frequency bands from about 13.6 MHz to about 16 MHz (a frequency bandwidth of about 2.4 MHz), for example.

Therefore, since the RFID device having the characteristic curve A has a relatively narrow bandwidth but has a large communication distance limit, this RFID device can be used as a communication-distance-priority RFID device. Since the RFID device having the characteristic curve B has a relatively short communication distance limit but has a wide bandwidth, this RFID device can be used as a bandwidth-priority RFID device. It was discovered that both the communication distance and the bandwidth can be significantly increased, as compared to the RFID device having the characteristic curve C, which is a comparative example. In particular, the bandwidth-priority RFID device can provide a bandwidth as large as about 4.2 MHz/2.4 MHz=1.75 times that of the comparative example, for example.

### Fourth Preferred Embodiment

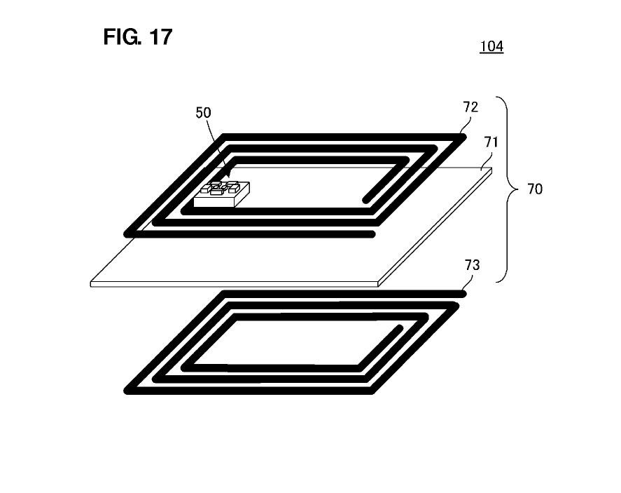

FIG. 17 is an exploded perspective view of an RFID module 104 according to a fourth preferred embodiment. The RFID module 104 includes a booster element 70 and an RFID device 50. The booster element 70 includes an insulating base 71, a booster coil pattern 72 provided on an upper surface of the insulating base 71, and a booster coil pattern 73 provided on a lower surface of the insulating base 71. In the illustration of FIG. 17, the booster coil patterns 72 and 73 are separated from the insulating base 71.

The RFID device 50 is preferably the same as that illustrated in the third preferred embodiment. The RFID device 50 is arranged on the insulating base 71 so that the coil of the coupling radiating element included in the RFID device 50 is magnetically coupled to the booster coil patterns 72 and 73.

In this manner, a booster element may be provided using a conductor coil pattern.

### Fifth Preferred Embodiment

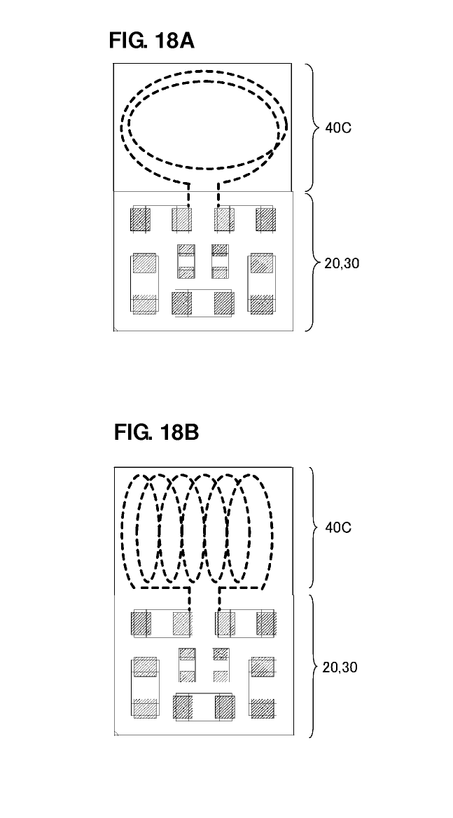

In a fifth preferred embodiment of the present invention, another example configuration of the coupling radiating element 40C is illustrated. FIG. 18A and FIG. 18B are diagrams illustrating two configurations of an RFID device according to the fifth preferred embodiment. In the third preferred embodiment, the coupling radiating element 40C is disposed in a multi-layer substrate so that the coupling radiating element 40C overlaps the filter circuit 20 and the matching circuit 30 when viewed in plan. In the examples illustrated in FIG. 18A and FIG. 18B, the coupling radiating element 40C is disposed on a side of the filter circuit 20 and the matching circuit 30. In the example illustrated in FIG. 18A, the coupling radiating element 40C is disposed so that the loop surface of the coupling radiating element 40C is parallel or substantially parallel to the plane of the multi-layer substrate. In the example illustrated in FIG. 18B, the coil axis direction of the coupling radiating element 40C is parallel or substantially parallel to the plane of the multi-layer substrate.

In this manner, the coupling radiating element 40C may be provided on a side of the filter circuit 20 and the matching circuit 30.

### Other Preferred Embodiments

In the foregoing preferred embodiments, a non-limiting example in which a plurality of loop-shaped conductors are rectangular or elliptical (oval) when viewed in plan is illustrated; however, a plurality of loop-shaped conductors may be circular or octagonal when viewed in plan, or may have any other polygonal shape.

In addition, each layer of a multi-layer substrate may be a non-magnetic dielectric layer, if desired.

In addition, the RFID module 103 illustrated in FIG. 14 preferably includes the booster element 60 as an antenna, and the RFID module 104 illustrated in FIG. 17 preferably includes the booster element 70 as an antenna. However, a radiating conductor to be electromagnetically coupled to any of the above booster elements may be further provided, and the radiating conductor together with the booster element may act as an antenna.

Furthermore, a matching circuit may not only include a capacitance element but may also include only an inductance element or include a capacitance element and an inductance element, if desired.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An RFID module comprising:
an RFIC element including a first input/output terminal and a second input/output terminal;
a filter circuit that removes harmonic components of the RFIC element, the filter circuit including a first inductance element connected to the first input/output terminal, and a second inductance element connected to the second input/output terminal; and
a radiating element connected to the filter circuit; wherein
the first inductance element and the second inductance element are magnetically coupled to each other.

2. The RFID module according to claim 1, wherein a coupling coefficient between the first inductance element and the second inductance element is greater than or equal to about 0.7.

3. The RFID module according to claim 1, further comprising a matching circuit connected between the filter circuit and the radiating element, the matching circuit including an inductance element and a capacitance element or including an inductance element or a capacitance element.

4. The RFID module according to claim 1, wherein the first inductance element includes a first laminated coil element in which a plurality of loop-shaped conductors are laminated, the second inductance element includes a second laminated coil element in which a plurality of loop-shaped conductors are laminated, and a winding axis of the loop-shaped conductors of the first laminated coil element is substantially aligned with a winding axis of the loop-shaped conductors of the second laminated coil element.

5. The RFID module according to claim 4, wherein the loop-shaped conductors of the first laminated coil element and the loop-shaped conductors of the second laminated coil element are alternately laminated.

6. The RFID module according to claim 1, wherein the first inductance element and the second inductance element are included in a multi-layer substrate including a plurality of magnetic layers laminated on each other.

7. The RFID module according to claim 6, wherein the inductance element or the capacitance element of the matching circuit is mounted on a surface of the multi-layer substrate.

8. The RFID module according to claim 1, further comprising a booster element that is coupled to the radiating element through an electromagnetic field and that receives or transmits a radio signal.

9. The RFID module according to claim 8, wherein the radiating element includes a coil-shaped conductor, and the coil-shaped conductor and the booster element are electromagnetically coupled to each other.

10. The RFID module according to claim 8, wherein the radiating element is included in the multi-layer substrate.

11. An RFID device disposed between an RFIC element and a radiating element, the RFIC element including a first input/output terminal and a second input/output terminal, the RFID device comprising:
a filter circuit that removes harmonic components of the RFIC element, the filter circuit including a first inductance element connected to the first input/output terminal, and a second inductance element connected to the second input/output terminal, wherein the first inductance element and the second inductance element are magnetically coupled to each other.

12. The RFID device according to claim 11, further comprising a matching circuit connected on a side of the filter circuit which adjacent to the radiating element, the matching circuit including an inductance element and a capacitance element or including an inductance element or a capacitance element.
